(19) United States
(12) Patent Application Publication
(10) Pub. No.: US 2014/0320592 A1
(43) Pub. Date: Oct. 30, 2014

(54) Virtual Video Camera

(71) Applicant: Microsoft Corporation, Redmond, WA (US)

(72) Inventors: Louis Amadio, Sammamish, WA (US); Eric Glenn Lang, Bellevue, WA (US); Michael M. Gutmann, Duvall, WA (US)

(21) Appl. No.: 13/915,610

(22) Filed: Jun. 11, 2013

Related U.S. Application Data
(60) Provisional application No. 61/817,811, filed on Apr. 30, 2013.

(51) Int. Cl. H04N 5/262

(52) U.S. Cl. CPC H04N 5/262
USPC 348/36

(57) ABSTRACT

The subject disclosure is directed towards a technology in which a virtual camera composes a plurality of views obtained from one or more physical and/or synthetic cameras into a single video stream, such as for sending to a remote telepresence client. The virtual camera may appear to applications as a single, real camera, yet provide video composed from multiple views and/or sources. Transforms may be applied at the virtual camera using hardware acceleration to generate the views, which are then composed into a rendered view and output to a video pipeline as if provided by a single video source.

### CROSS-REFERENCE TO RELATED APPLICATION

The present application claims priority to U.S. provisional patent application Ser. No. 61/817,811 filed Apr. 30, 2013.

### BACKGROUND

Telepresence involves transmitting video to a remote location, generally so that a remote viewer feels somewhat present in a meeting room or the like with other participants. One desirable way to present telepresence video to users is to provide a panoramic view of a meeting room showing the participants, in conjunction with another view, such as a close-up view of a person speaking, a whiteboard, or some object being discussed. The other view is typically controllable via pan and tilt actions and the like.

However, contemporary video transports such as Microsoft® Lync® and other legacy software only support a single camera. Thus, such transports/software are not able to provide such different views to users.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a virtual camera configured to compose frames of video corresponding to views into frames of video from a single source for rendering. The virtual camera includes a compositor component having a rendering loop that processes frame data corresponding to the plurality of views into composed frame data to provide the composed frame data to a video pipeline at a desired frame rate.

In one aspect, sets of frame data corresponding to a plurality of views from one or more video sources are received at a server-side computing environment. A single video frame is composed from the sets of frame data, including storing frame data corresponding to the frames in GPU memory, and processing the frames in GPU memory to obtain a rendered frame in CPU memory. The rendered frame is output to a remote client-side application as part of a video stream.

One or more aspects are directed towards obtaining video frames from at least one physical camera and/or a synthetic camera. The video frames are processed to synthesize or compose the video frames into a resultant frame. The resultant frame is send to a remote recipient as part of a video stream from one video source. A transform or transforms may be applied to transform frame data corresponding to at least one of the video frames.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components configured to provide a virtual camera, according to one example implementation.

FIG. 2 is a block diagram representing example components by which a virtual camera may apply transforms to frame data to provide a series of frames composed from multiple views to a remote client as a series of frames from a single camera source, according to one example implementation.

FIG. 3 is a block diagram representing example components of one configuration, by which a virtual camera provides a series of rendered frames composed from multiple views and/or sources, according to one example implementation.

FIG. 4 is a dataflow diagram representing example interactions between components for composing multiple views from one or more video sources into rendered frames, according to one example implementation.

FIG. 5 is a flow diagram representing example steps for composing views into virtual camera frames, according to one example implementation.

FIG. 6 is a representation of how data from a synthetic source may be composed with frame data from a physical camera to provide an augmented reality video that may be sent to a remote application, according to one example implementation.

FIG. 7 is a block diagram representing exemplary non-limiting networked environments in which various embodiments described herein can be implemented.

FIG. 8 is a block diagram representing an exemplary non-limiting computing system or operating environment in which one or more aspects of various embodiments described herein can be implemented.

### DETAILED DESCRIPTION

Various aspects of the technology described herein are generally directed towards a virtual video camera (e.g., a software-based video camera) that is connected to one or more video sources and composes and/or transforms the source or sources into a virtual camera view. The software video camera thus may appear to an application program as any other single camera, and moreover, may result in the same amount of data being transmitted over the network as if a single physical camera was being used, conserving bandwidth. Thus, for example, a panoramic view captured by one physical camera may be composed with a close-up view captured by another physical camera into a single video frame, with sequential composed frames transmitted to a remote location for output. Alternatively, the same camera may capture a frame at a high resolution, select part of the high-resolution frame (e.g., a close-up) as one source, downsample the frame (e.g., into a lower-resolution panoramic view) as another source, and compose the high-resolution part with the downsampled part into a single video frame that includes the close-up and the panoramic view.

In one aspect, the software video camera takes video frames from one or more physical or synthetic cameras, processes the video frames, and synthesizes new images and/or composes the video frames together, (e.g., in a computer video card's hardware). The software video camera may optionally apply image transforms; such image transforms may be applied in real time, e.g., using hardware acceleration. The software video camera repackages the resulting frames and sends the frames further down a video pipeline

A hosting application as well as a receiving client application thus may operate as if the virtual camera is a single real camera. This allows the virtual camera to be compatible with legacy software that expects to interface with a single camera. A hosting application may instruct the virtual camera which source or sources to use, how to compose the frames and/or what transforms are to be applied.

It should be understood that any of the examples herein are non-limiting. For instance, one example implementation is based upon Microsoft Corporation's DirectShow®, DirectX® and Media Foundation technologies. However, this is only one example, and other video capture and processing environments may similarly benefit from the technology described herein. Further, any transmitted video may benefit from the technology, not only video transmitted for use in telepresence applications. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and video technology in general.

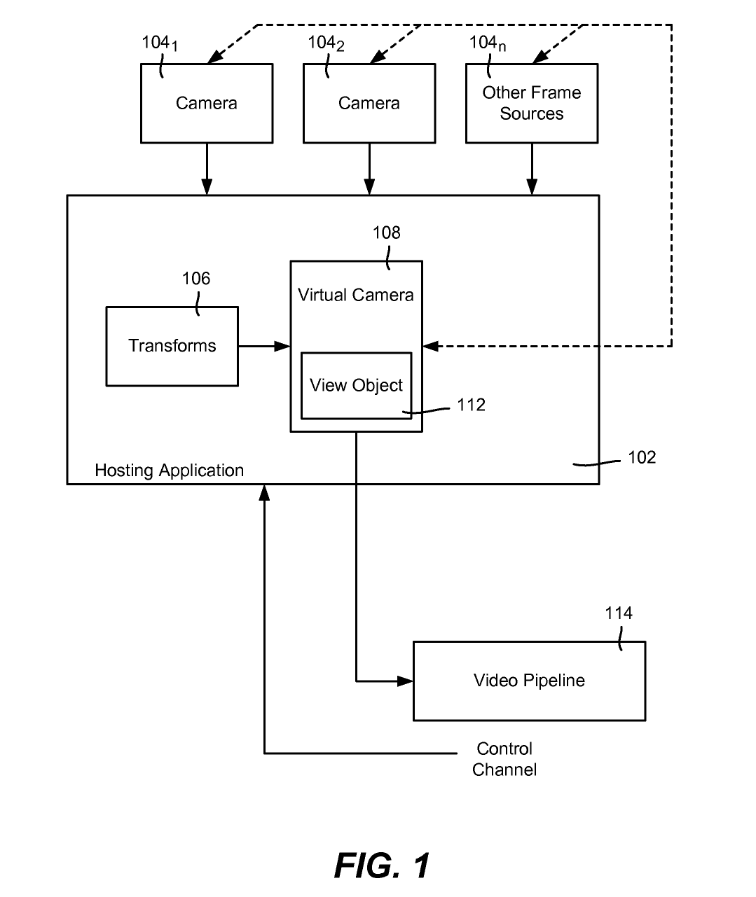

FIG. 1 is a simplified block diagram representing example components that show some general concepts and aspects of the technology described herein. In general, a hosting application 102 decides what cameras and/or other frame sources 1041-104n (also referred to as synthetic cameras) to compose and what transforms 106 (if any) need to be applied for a given scenario. This may be based on client-side instructions to a server-side hosting application, for example. The hosting application 102 selects one or more physical and/or synthetic cameras to compose frames for a virtual camera 108.

Note that the virtual camera 108 may publish itself as available like any other camera, for example, and is thus discoverable to any of various applications that use cameras. For example, in a DirectShow® configuration, the virtual camera may be registered as a camera source filter. When an application attempts to use a DirectShow® camera, the application may enumerate the available video source filters. Alternatively, such DirectShow® filter functions may be within the application. When the virtual camera DirectShow® filter is added to a graph, an API is published, e.g., via the COM running object table. This API is what the hosting application uses to discover the virtual camera, and to control it.

By way of example, via a suitable interface, the hosting application 102 may instruct the virtual camera 108 to connect to one or more specific physical video cameras and/or one or more other software frame sources 104₁-104ₙ, (e.g., one or more synthetic cameras, sources of pre-recorded video and so on), as represented by the dashed lines in FIG. 1. Examples of other software frame sources 104₁-104ₙ include sources of animations, graphics, pre-recorded video and so forth, which as described herein may be composed into the final video output.

Once configured, the virtual camera 108 collects a frame from each of the one more physical or synthetic cameras, composes the frame or frames into a single video frame via a view object 112 as described below, and presents this frame to a video pipeline 114 such as to a Multimedia Framework Component, (e.g., a DirectShow® filter graph hosted in an application). To achieve this, the virtual camera 108 internally sets up rendering graphs for each physical camera or other camera as directed by the application. In one implementation, the physical/other camera rendering stack may comprise a Media Foundation rendering topology with its output stage directed into a DirectX® texture.

In one implementation, each frame may be presented using the highest resolution and frame rate for the camera. To select the format for the camera, the resolution and frame rates supported are enumerated. The frame rate is selected to closely match the output frame rate (e.g., 30 fps), with the highest resolution that supports this frame rate selected.

Thus, via instructions to the virtual camera 108, the hosting application 102 creates a ‘view’ on the virtual camera 108 comprising an object 112 that represents the actual transforms, placement and/or animations for the video source or sources, e.g., by including presentation parameters, a mesh and animation properties. The hosting application 102 connects the virtual camera 108 into the video pipeline 114 as if the virtual camera 108 was a real camera.

In general, a synthetic frame source is a piece of application software that can present frames. An application can create multiple frame sources. The synthetic frame source is used for overlaying graphics or other geometry into the camera scene, which is then used to construct the frames for the virtual camera.

Transforms also may be used to change a scene. By way of one example of a transform, consider a physical camera having an attached fish eye lens or other image warping lens. The software (virtual) camera 108 is selected by a server-side instance of the hosting application 102, e.g., a server-side application such as Skype® or Lync®. The hosting application 102 may request that the virtual camera 108 apply a de-fishing/de-warping transform, using hardware video acceleration to perform the actual de-fishing/de-warping operation.

As another example, consider an ultra-high definition camera attached to the system, in which the camera has far greater resolution than can be practically transmitted over a conventional (e.g., Ethernet) network connection. A virtual camera may be installed and instructed to create multiple views of the ultra-high definition image, such as a single full image scaled down in resolution, as well as a small detailed (at a higher resolution) image positioned within the full image at a host-instructed location. These two views of the camera are composed and presented in a single frame to the hosting application, as if one camera captured both the lower resolution full image and the higher resolution detailed image in a single exposure.

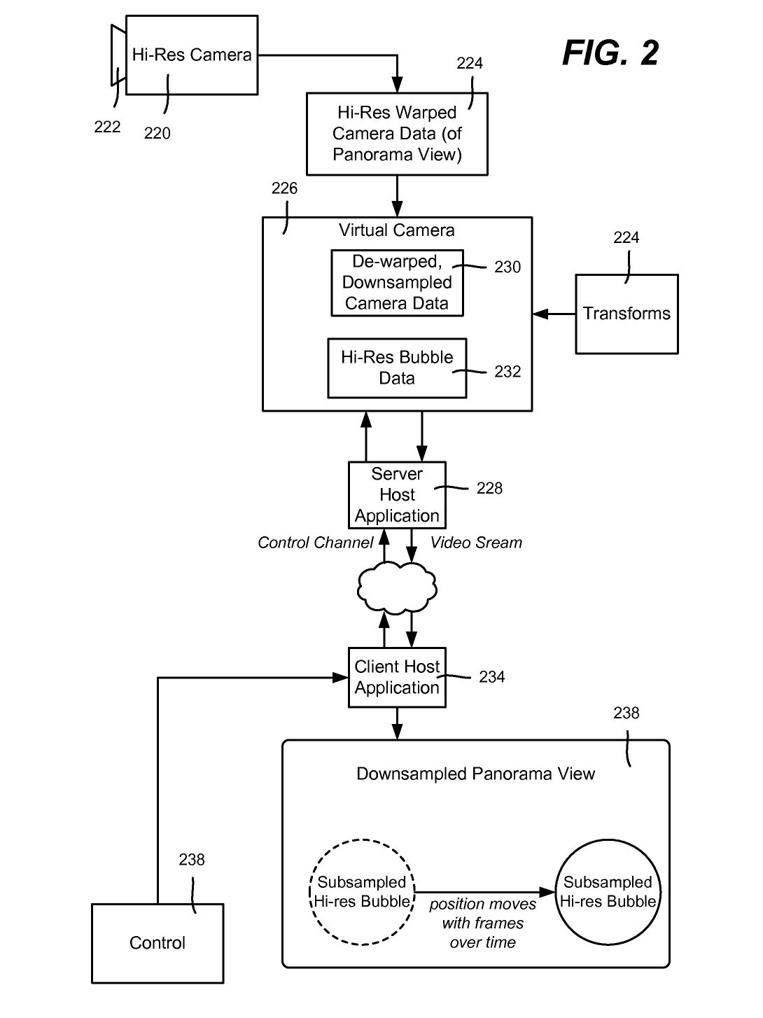

Further, note that the above-exemplified transforms may be combined, e.g., the ultra-high definition camera view can remove the fisheye effect, before doing the downsample (e.g., to 1080p) and extraction of the detailed image. This is represented in FIG. 2, where a high resolution camera 220 with a fish-eye or other warping lens 222 produces camera data frames 224, e.g., of a high resolution warped panorama view.

A virtual camera 226, as instructed by a server-side host application 228, applies transforms to de-warp and downsample each high resolution frame 224 into a full image (block 230). Another transform “cuts” a subpart/piece (e.g., a circular data “bubble’ 232) of the higher resolution image and composes the subpart piece and the full image into a single frame, basically superimposing the cut piece over the full image which is now another subpart of the single frame. Note that some downsampling/scaling and zooming may be performed on the cut subpart; example bubble parameters may include a given point of focus, a radius and a zoom factor. The final frame is sent to the client host application 232 as part of a video stream (after any reformatting as appropriate for transmission and/or output). Note further that more than one piece may be cut from a single set of frame data, e.g., more than one bubble may be cut and composed as high-resolution subparts over the lower-resolution image subpart that remains as “background” frame data.

As shown in FIG. 2, the client host application 234 renders the frame as visible data containing a representation of the panorama view data 230 and bubble data 232 to a display 238. The client host application gets the frame in this form, and renders the output as if captured by a single camera; (note however it is feasible for the client host application or another application to further process the frame data).

As also exemplified in FIG. 2, the bubble may be repositioned over a number of frames, e.g., via animation or manual control (or possibly other control, such as via an automated client-side process). With respect to manual control, a user has an input device 238 such as a game controller, mouse, remote control and so forth that allows the virtual camera to be manipulated. Speech and/or gestures may be detected to control the camera. Indeed, control may be facilitated by conventional interfaces such as a mouse, keyboard, remote control, or via another interface, such as Natural User Interface (NUI), where NUI may generally be defined as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other categories of NUI technologies include touch sensitive displays, voice and speech recognition, intention and goal understanding, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, as well as technologies for sensing brain activity using electric field sensing electrodes.

In general, the control 238 provides a control channel (backchannel) via the client host application 234 to the server host application 228 to provide for controllable views. As described herein, the virtual camera has an API called by the server host application 228. Via commands, the control channel through the API allows a user to perform operations such as to change the composition of cameras or sub-cameras, create a synthetic view inside of a virtual camera view, position a bubble, change a zoom factor, and so on. Basically the control channel allows a user to modify the transforms/transform parameters on any camera. The server host application interprets such commands to make changes, basically modifying the transforms transform parameters on one or more cameras being composed. Augmented reality, described below, also may be turned on or off, or changed in some way. Note that the control channel also may be used to move one or more physical cameras, e.g., to rotate a physical device and so forth from which the virtual camera obtains its frame data.

As another example of a transform, consider a synthetic video frame and 3D vision processing. Multiple cameras pointing at a subject are connected to the virtual camera. The video frames are processed to extract key data points, which can be correlated between the connected physical cameras. The technology described herein composes those frames to generate a 3D representation of the scene. From this 3D representation, a flat synthetic video frame can be sent to the hosting application. Additionally, the synthetic 3D frame can have other data composed, such as software-only 3D objects representing detected data in various ways. Additionally, the synthetic 3D video frame can be altered to change the perception point, such as shifting the image for gaze correction.

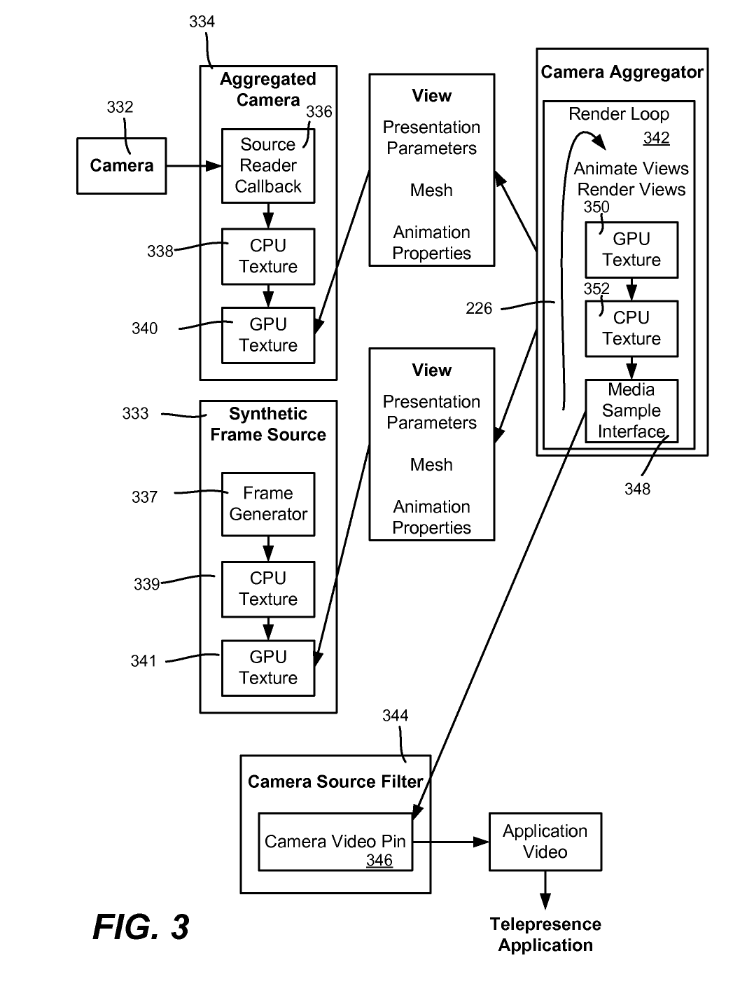

FIG. 3 shows additional detail in an example of a virtual camera 330 implemented in an example video processing framework. For example, in a Windows® environment, three known technology stacks may be leveraged to provide a virtual camera 330, e.g., Windows® Media Foundation may be used to obtain data from one or more local cameras/frame sources (e.g., camera 332), DirectX® may be used as a composition and rendering framework, and DirectShow® may be used to get the frame data into the client transport (e.g., telepresence) application, (e.g., Skype® or Lync®).

Internally, the virtual camera 330 establishes connections with the frame sources, e.g., one or more real cameras, pre-recorded frame sources and/or synthetic cameras generating frames at a regular interval. For purposes of brevity, a single physical camera 332 is shown as a source in FIG. 3, with its data transformable in different ways into a composed view, however as is understood, multiple physical camera sources may be providing frames.

FIG. 3 also includes a synthetic frame source 333, (there may be multiple synthetic frame sources). An application is responsible for creating and registering the synthetic frame source 333 with the virtual camera device. The application also responsible for the communication channel between any camera frame processing handlers and the synthetic frame source or sources.

As described herein, one part of the virtual camera comprises an aggregated camera 334 (referred to as aggregated even if only one is present), which in a Windows® Media Foundation environment, obtains frames through a callback mechanism 336 (e.g., SourceReaderCallback) from each selected camera. At a selected frame rate for each selected video camera, frames are read into a staging graphics texture in the computer's main memory, shown as CPU texture 338.

More particularly, in one implementation, the physical camera graph runs on its own thread. When a frame callback is received, the frame is copied into a CPU-bound texture 338, e.g., a DirectX® texture. This operation is done on the CPU, and is done on a free threaded texture. A copy operation is queued to copy the CPU bound texture 338 into a GPU-bound texture 340; this texture is then asynchronously copied into a hardware accelerated texture in the graphics card's memory. Once the copy is started, the physical camera is free to present another frame, which prevents blocking the rendering thread.

Note that the application can register a camera frame processing callback. In this way, the application may be given access to the frame, prior to presenting to the GPU. The application can use the frame data for processing, e.g., such as for performing face detection or object recognition as desired.

The synthetic frame source 333 operates similarly, except that instead of a physical camera source/callback mechanism, a frame generator (e.g., in software or via software that obtains frames from pre-recorded video) generates the frame data. Note that at the creation of the synthetic frame source, the source is given access to the CPU texture, the GPU texture and the (e.g., DirectX®) object, which allows it to create its own shaders. The copying of the CPU texture 339 into the GPU texture 341 may operate in the same way as described above, including that the application may process the CPU texture data before the copy to the GPU hardware.

Each physical or synthetic camera thus sets up a texture that serves as input to a render process (including loop) 342 of the virtual camera that produces a final output. Note that in a Windows® environment, DirectShow® provides a filter 344 (CameraSourceFilter) and pin 346 (CameraVideoPin, where in general pins comprise COM objects that act as connection points by which filters communicate data); the CameraVideoPin connects to the cameras and sets up the render loop 342. The render loop 342 may be a DirectX® construct that sets up the necessary 3D geometry, samples the textures and composes the geometry.

Textures are input into the render process, whereby the render loop 342 performs the transforms such as to do any lens distortion correction, apply any secondary effects (e.g., bubble effect), apply any overlay, and so on. After applying any transforms, the render loop 342 outputs each final frame through an interface to a receiving entity. In a Windows® environment, in which the camera aggregator is a DirectX® component, one implementation of the render loop 342 outputs from an interface 348 (e.g., IMediaSample) to the camera video pin of DirectShow®, (CameraVideoPin) of the camera source filter (CameraSourceFilter).

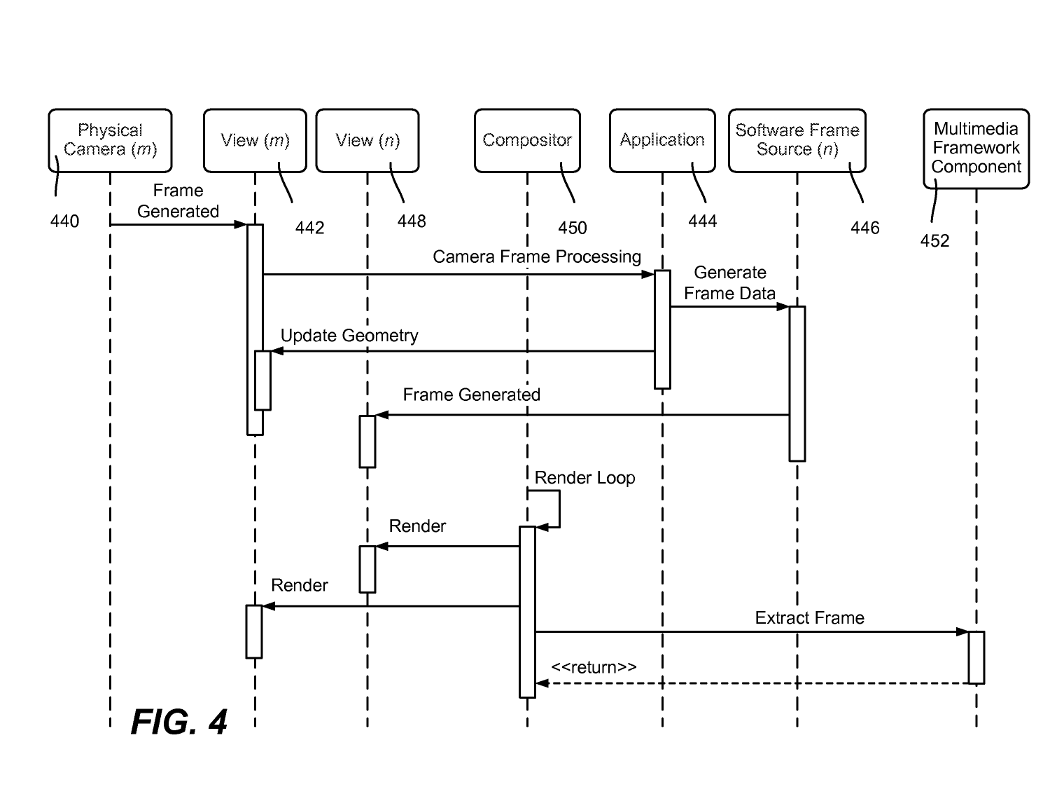

FIG. 4 exemplifies the above concepts in a data flow diagram. A physical camera 440 (e.g., one of m such cameras) generates a frame of data which is used by a view 442, wherein a view comprises an object that is responsible for creating the needed rendering geometry, shaders and animation properties. Multiple (e.g., m) views are supported, and multiple views of a frame source are allowed. During view creation, the passed (e.g., DirectX®) object is used to create the needed vertex buffers, index buffers, and shader objects. The view 442 is given a pointer to a frame source that will be used for texture mapping to the geometry. As described above, the application 444 is given an opportunity to process the frame data, e.g., to update the geometry for the view 442.

A software frame source 446 (e.g., one of n such sources) similarly generates frame data in a view 448. Although not shown in FIG. 4, it is feasible for the application 444 to process the frame data.

The compositor 450 generates the output frame for the virtual camera's framework component 452, (e.g., a DirectShow® filter). The compositor 450 manages the (e.g., DirectX®) rendering pipeline. At startup, the compositor 450 creates a top level (e.g., DirectX®) object. The compositor then uses this object to create a render target, which is used to collect the rendered views into the camera output frame. The compositor 450 generates the backing texture for the render target and the CPU staging texture that is used to extract the frame buffer. After the camera views are rendered, the render target's backing texture is copied to a CPU staging texture, which is then locked to extract the rendered bits.

After construction, the compositor 450 may generate blank frames as it waits for views to be added to the rendering queue. As views are added, the rendering loop iterates through the views before generating the frame in the media sample interface (e.g., MediaSample) for the hosted graph.

As described above with reference to FIG. 3, in one implementation the DirectShow® Filter implements a single pin, comprising the pin that produces the image media samples. The video pin is responsible for format negotiation with the hosted graph and downstream filters. Once the video pin completes this negotiation, the pin creates the frame compositor, and then begins generating frames.

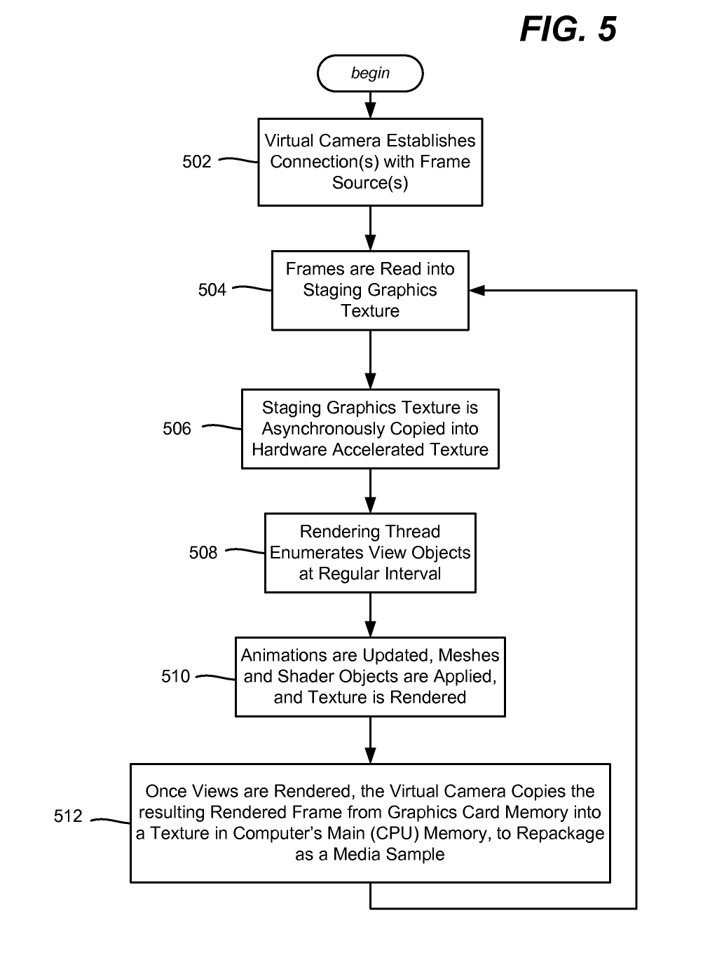

FIG. 5 summarizes some of the operations described herein in the form of example steps, beginning at step 502 where the virtual camera establishes connections with the frame sources. At step 504, frames are read into a staging graphics texture, and at step 506 the texture is copied (e.g., asynchronously) into a hardware accelerated texture in the graphics card's memory.

At a regular interval, represented by step 508, a rendering thread enumerates the view objects. At step 510, animations are updated, meshes and shader objects are applied, and the texture is rendered. Once the views are rendered, the virtual camera copies the resulting rendered frame from the graphic card's memory into a texture in the computer's main memory, where it is repackaged as a media sample for further processing by the hosting application's video pipeline (step 512)

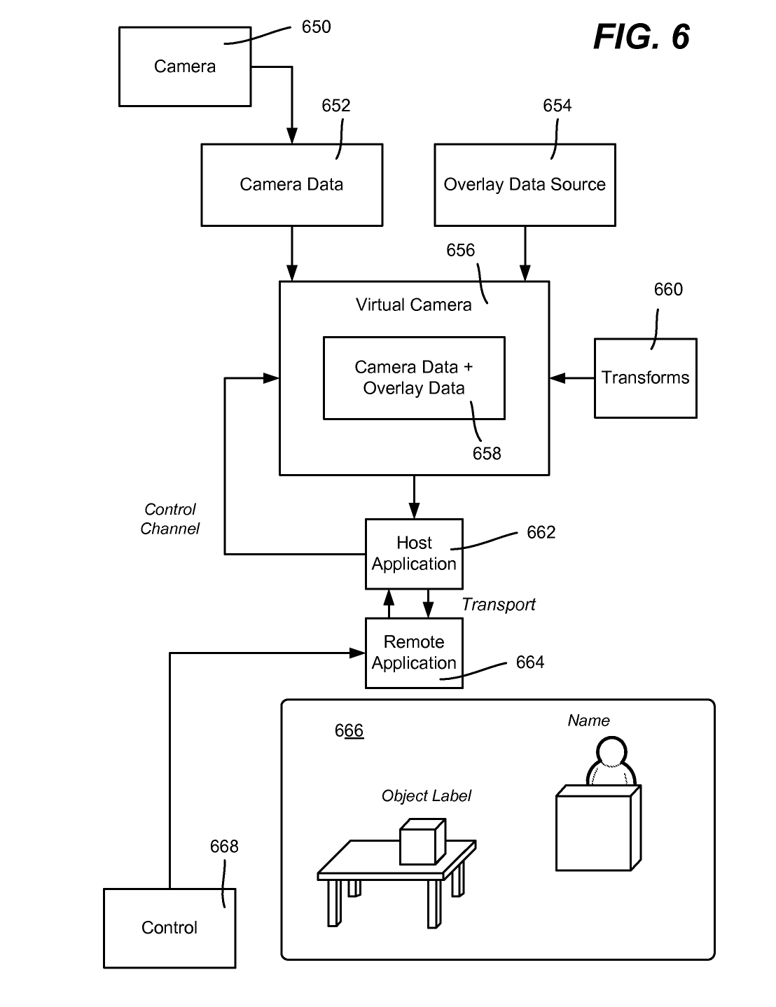

Turning to another aspect, one of the sources may provide augmented reality data or other superimposed data that is composed as part of the image. To this end, as represented in FIG. 6, a camera 650 provides camera data 652, and an overlay data source 654 provides overlay data. Example overlay data may comprises “projected” text or graphics, virtual avatars that sit and/or move in the display, information or virtual objects that may be hovered atop the underlying video stream, and so forth.

As described herein, a virtual camera instance 656 composes the camera data 652 and overlay data 654 into a composed set of frames 658 comprising the combined camera data 652 and overlay data 654, using any transforms 660 as instructed by a host application 662. When a remote application 664 receives the video stream, the combined camera data and overlay data 658 are already present in each frame. Thus, as represented in the rendered frame 666, a view may have a person's name label hover above the person's image, an object may be labeled and so forth. Animations may move avatars, labels, virtual objects and so forth among the frames as desired.

As described above, a user may control (block 668) the overlay data. For example, a user may turn off an avatar, turn off labeling, request enhanced labeling (e.g., not just view a person's name but a short biography about that person) and so forth. As described herein, any and all of the composition may occur via the virtual camera at the server side, whereby the remote client application only needs to receive and render a video stream, as many types of client applications are already configured to do.

Note that using a high performance graphics processor allows manipulating the video stream with various effects before outputting to the remote stream.

It should be noted that while the technology described herein was described with reference to combining multiple sources of data (e.g., multiple cameras or different views from a single camera) into a single frame of data, the technology may output more than a single frame. For example, instead of a single virtual camera, a virtual camera may comprise two sets of components that are each able to compose video from multiple sources, and thus may be used as input to an application expecting stereo camera input. A program that receives stereo camera input may receive input from a first camera that is not a virtual camera and a second camera that is a virtual camera. Basically, anywhere camera input (single or stereo) is expected, a virtual camera or a set of virtual cameras may be substituted to provide that input.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

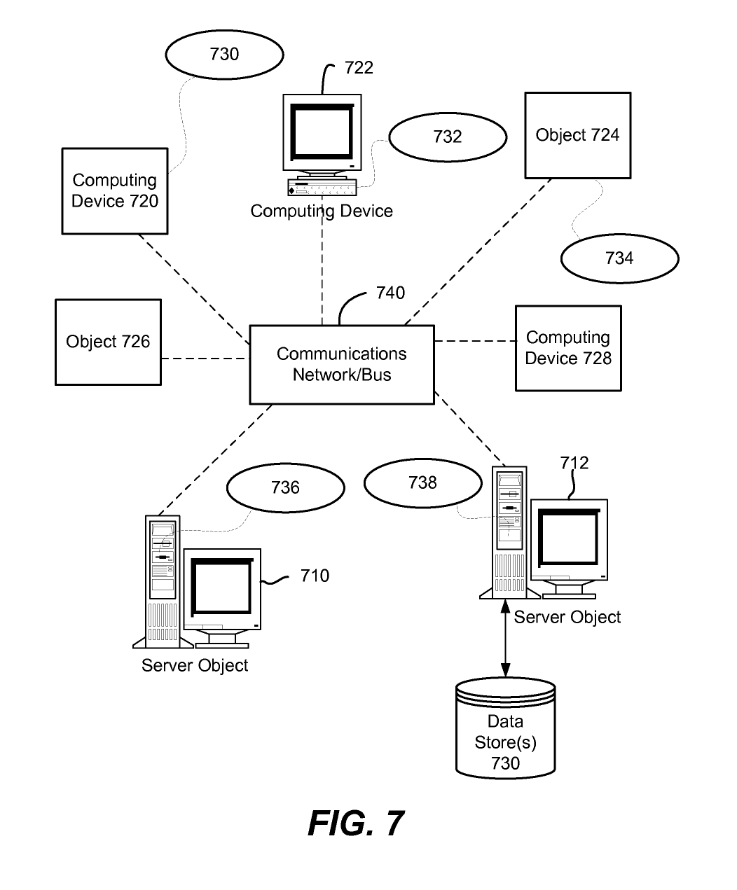

FIG. 7 provides a schematic diagram of an exemplary networked or distributed computing environment. The distributed computing environment comprises computing objects 710, 712, etc., and computing objects or devices 720, 722, 724, 726, 728, etc., which may include programs, methods, data stores, programmable logic, etc. as represented by example applications 730, 732, 734, 736, 738. It can be appreciated that computing objects 710, 712, etc. and computing objects or devices 720, 722, 724, 726, 728, etc. may comprise different devices, such as personal digital assistants (PDAs), audio/video devices, mobile phones, MP3 players, personal computers, laptops, etc.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, communications network 740 may comprise other computing objects and computing devices that provide services to the system of FIG. 7, and/or may represent multiple interconnected networks, which are not shown. Each computing object 710, 712, etc. or computing object or device 720, 722, 724, 726, 728, etc. can also contain an application, such as applications 730, 732, 734, 736, 738, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc., acting as servers provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 740 or bus is the Internet, for example, the computing objects 710, 712, etc. can be Web servers with which other computing objects or devices 720, 722, 724, 726, 728, etc. communicate via any of a number of known protocols, such as the hypertext transfer protocol (HTTP). Computing objects 710, 712, etc. acting as servers may also serve as clients, e.g., computing objects or devices 720, 722, 724, 726, 728, etc., as may be characteristic of a distributed computing environment.

### Example Computing Device

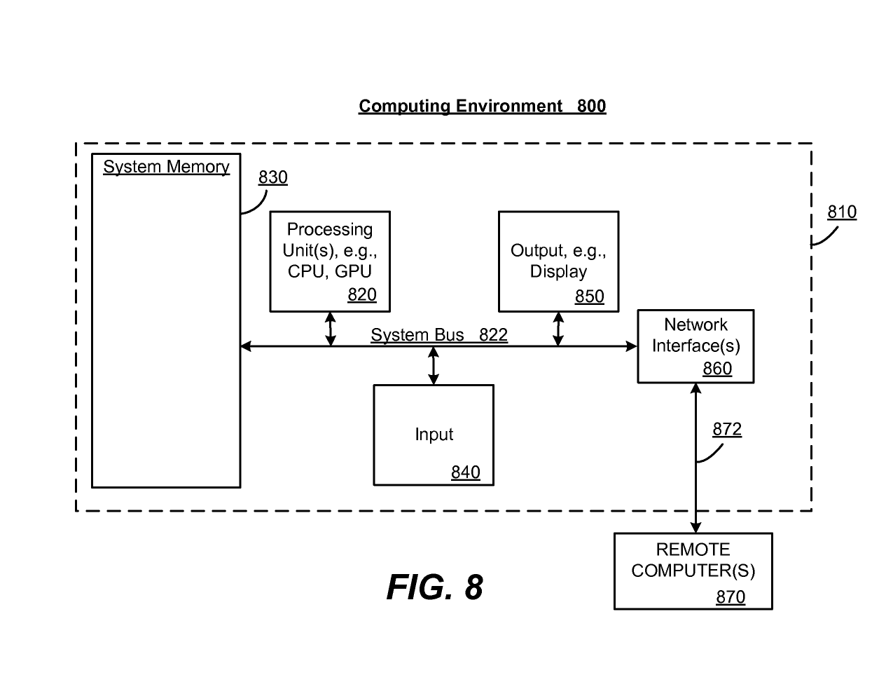

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 8 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. In addition, the computing system environment 800 is not intended to be interpreted as having any dependency relating to any one or combination of components illustrated in the exemplary computing system environment 800.

With reference to FIG. 8, an exemplary remote device for implementing one or more embodiments includes a general purpose computing device in the form of a computer 810. Components of computer 810 may include, but are not limited to, a processing unit 820, a system memory 830, and a system bus 822 that couples various system components including the system memory to the processing unit 820.

Computer 810 typically includes a variety of computer readable media and can be any available media that can be accessed by computer 810. The system memory 830 may include computer storage media in the form of volatile and/or nonvolatile memory such as read only memory (ROM) and/or random access memory (RAM). By way of example, and not limitation, system memory 830 may also include an operating system, application programs, other program modules, and program data.

A user can enter commands and information into the computer 810 through input devices 840. A monitor or other type of display device is also connected to the system bus 822 via an interface, such as output interface 850. In addition to a monitor, computers can also include other peripheral output devices such as speakers and a printer, which may be connected through output interface 850.

The computer 810 may operate in a networked or distributed environment using logical connections to one or more other remote computers, such as remote computer 870. The remote computer 870 may be a personal computer, a server, a router, a network PC, a peer device or other common network node, or any other remote media consumption or transmission device, and may include any or all of the elements described above relative to the computer 810. The logical connections depicted in FIG. 8 include a network 872, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A system comprising, a virtual camera configured to compose frames of video corresponding to a plurality of views into frames of video from a single source for rendering, the virtual camera including a compositor component having a rendering loop that processes frame data corresponding to the plurality of views into composed frame data to provide the composed frame data to a video pipeline at a desired frame rate.

2. The system of claim 1 wherein the virtual camera publishes information that represents the virtual camera as a conventional camera to an application program.

3. The system of claim 1 wherein the compositor component processes the frame data based upon a plurality of view objects that each creates at least one: of rendering geometry, shaders or animation properties associated with the frame data corresponding to a view.

4. The system of claim 1 wherein the compositor component is further configured to perform at least one transform on at least one set of frame data.

5. The system of claim 4 wherein the compositor component performs the at least one transform using zero or more hardware accelerated transforms.

6. The system of claim 4 wherein the at least one transform comprises a de-warping transform.

7. The system of claim 4 wherein the zero or more transforms comprise a transform that processes high-resolution frame data into a higher-resolution subpart and downsampled lower-resolution frame data into a lower-resolution subpart, the higher-resolution subpart comprising one of the plurality of views and the downsampled lower-resolution frame data comprising another of the plurality of views that are composed into a frame of video from a single source for rendering.

8. The system of claim 1 wherein at least one of the plurality of views is generated by zero or more synthetic frames.

9. The system of claim 8 wherein the synthetic frame source comprises a source of at least one of: animation, superimposed data, graphics, text, or prerecorded video frame data.

10. The system of claim 1 wherein the virtual camera is coupled to a telepresence application.

11. The system of claim 1 wherein the video pipeline is coupled to a remote renderer via a network connection.

12. The system of claim 11 further comprising a control channel associated with the remote renderer to receive instructions for controlling the virtual camera.

13. The system of claim 12 wherein the virtual camera is configured to modify a transform or a transform parameter, or both, based upon an instruction received via the control channel

14. The system of claim 1 wherein the virtual camera obtains the frame data in CPU memory, has the frame data copied from the CPU memory to GPU memory for the composition component to compose into rendered frame data, and copies the rendered frame data from the GPU memory into CPU memory.

15. A method comprising:
at a server-side computing environment, receiving sets of frame data corresponding to a plurality of views from one or more video sources;
composing a single video frame from the sets of frame data including storing frame data corresponding to the frames in GPU memory, and processing the frames in GPU memory to obtain a rendered frame in CPU memory; and
outputting the rendered frame to a remote client-side application as part of a video stream.

16. The method of claim 15 further comprising transforming the frame data received from a single camera into the plurality of views.

17. The method of claim 15 further comprising establishing a connection with each of one or more frame sources and obtaining frames from each source in CPU memory, and wherein storing the frame data in GPU memory comprises copying from the CPU memory.

18. The method of claim 17 further comprising, providing the frames to an application for processing before copying from the CPU memory.

19. One or more computer-readable storage media or logic having computer-executable instructions, which when executed perform steps, comprising, obtaining video frames from at least one physical camera or a synthetic camera, or both, processing the video frames to synthesize or compose the video frames into a resultant frame, and sending the resultant frame to a remote recipient as part of a video stream from one video source.

20. The one or more computer-readable storage media or logic of claim 19 having further computer-executable instructions comprising applying at least one transform to frame data corresponding to at least one of the video frames.
